(19) United States
(12) Patent Application Publication
(10) Pub. No.: US 2007/0241555 A1
(43) Pub. Date: Oct. 18, 2007

(54) Field replaceable sanitary hose end coupling

(76) Inventor: Elmer Scott Welch, Silver Lake, WI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/732,552

(22) Filed: Apr. 4, 2007

Related U.S. Application Data
(60) Provisional application No. 60/791,696, filed on Apr. 13, 2006.

(51) Int. Cl. F16L 33/00

(52) U.S. Cl. 285/255

(57) ABSTRACT

A coupling a hose end, including a hose barb defining a sanitary passage between an inner end securable to the hose and an outer end securable to a sanitary line, at least two malleable hose grips each defining a partially cylindrical segment having an outer diameter tapered from one end to the other, and an outer sleeve defining a central truncated conical passage which is tapered from one end to the other end to match the outer diameter taper of the hose grips. One end of each of the hose grips extends beyond the inner end of the hose barb to also surround a portion of the hose which is not over the hose barb inner end. A method of assembling the coupling uses a retaining sleeve which works in conjunction with the outer sleeve to hold and bias the hose grip against the hose as well as to release the hose grips during disassembly.

### CROSS REFERENCE TO RELATED APPLICATION(S)

This application claims priority to U.S. Provisional Application No. 60/791,696, filed Apr. 13, 2006.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention is directed toward hose end couplings, and particularly toward replaceable sanitary hose end couplings.

### BACKGROUND OF THE INVENTION AND TECHNICAL PROBLEMS POSED BY THE PRIOR ART

In many processing plants, hoses are utilized to transfer fluids, such as food or other critical products from vessels to equipment and between equipment and transfer lines, thereby reducing the number of lines and valves required. The hose and the end junction must be CIP (Clean In Place) cleanable as disassembly to hand clean is impractical and as almost all hoses are too long to hand clean. Sanitary standards require that such hoses and the connecting adapter be “crevice free” and CIP cleanable. Crevices when present will undesirably result in protected areas where unsanitary materials can accumulate and be difficult to clean and remove.

For practical applications requiring sanitary conditions, the connecting hose end must provide a pressure rating higher than the hose and the outer end must be a sanitary fitting to allow direct connection to a sanitary connection of a line or equipment. Thus, for example, the hose coupling in U.S. Pat. No. 4,212,487 may be unsuitable for sanitary conditions due to unsanitary conditions which can occur in the crevice around the hose at the end of the hose coupling.

Sanitary hoses such as used in the food Industries have different forms to meet the needs of the application. Hoses vary from “All Sanitary Clear Polymer” that can be visually inspected from the outside to “Heavy Built-up Hoses” with ‘Sanitary Liners’ covered by fabric or fabric and metal reinforcement sealed with a rubber or polymer covering.

In the United States, the majority of sanitary hoses are sized in inches by the inside diameter of the hose. The outer diameter of the hose (of any given inner diameter size) will vary because of the build up of the hose and the duty, while the inner diameter remains constant, complicating the task of ensuring proper sanitary connection.

Adequately mounting couplings to such hoses while also maintaining proper sanitary conditions is a constant struggle.

The present invention is directed toward overcoming one or more of the problems set forth above.

### SUMMARY OF THE INVENTION

In one aspect of the present invention, a coupling is provided for securing a hose to a sanitary line. The coupling includes a hose barb defining a sanitary passage between an inner end securable to a hose and an outer end securable to a sanitary line, the hose barb including a grooved annular outer surface about the sanitary passage adjacent the inner end. At least two malleable hose grips each define a partially cylindrical segment having a grooved inner diameter and an outer diameter tapered from one end to the other end, with the hose grips together being adapted to substantially surround a hose disposed over the hose barb grooved annular outer surface. An outer sleeve defines a central truncated conical passage which is tapered from one end to the other end to match the outer diameter taper of the hose grips. The hose grips are positioned to surround a hose disposed over the hose barb grooved annular outer surface, and one end of each of the hose grips extends beyond the inner end of the hose barb to also surround a portion of the hose which is not over the hose barb inner end. The hose grips are also sized to be spaced apart from one another along their edges, and the outer sleeve is sized so that when forced axially over the hose grips, the hose grips are pressed together and against the hose to create a pressure bond between the hose barb and the hose.

In one form of this aspect of the present invention, the hose barb grooved annular outer surface and the grooved inner diameter of the hose grips bind against the inner and outer surfaces of the hose, respectively In another form of this aspect of the present invention, the hose barbed grooved annular outer surface is adjacent to but spaced from the hose barb inner end.

In yet another form of this aspect of the present invention, the hose grips when pressed together have a pressure bond with the outer surface of the hose.

In a further form of this aspect of the present invention, the taper of the hose grips and the outer sleeve cylindrical opening is between about 3 and 6 degrees from the axial direction.

In still another form of this aspect of the present invention, the hose barb and outer sleeve are stainless steel.

In yet another form of this aspect of the present invention, the hose barb includes a radial step which is spaced from and faces the hose barb inner end, with the radial step face defining a stop for the end of a hose disposed over the hose barb inner end. In a further form, an annular stop ring has one annular face facing the hose barb inner end, with the annular face defining an axial stop for the hose grips which is spaced further from the hose barb inner end than the radial step.

In another form of this aspect of the present invention, an annular stop ring has one annular face facing the hose barb inner end, with the annular face defining an axial stop for the hose grips. In a further form, the outer sleeve has an end extending beyond the annular stop ring when secured over the hose grips, and a retaining ring is mountable in the outer sleeve truncated conical passage whereby the retaining ring engages the opposite annular face of the stop ring to retain the outer sleeve over the hose grips.

In still another form of this aspect of the present invention, the hose grips are selected according to the size of the hose.

In yet another form of this aspect of the present invention, the hose grips are selected according to the hardness and size of the hose.

In another aspect of the present invention, a method of securing a hose barb to a hose to create a sanitary connection is provided, including the steps of (a) locating the end of a hose over the inner end of the hose barb, (b) locating at least two malleable hose grips over the end of the hose and the hose barb inner end, wherein each hose grip defines a partially cylindrical segment having a grooved inner diameter and a tapered thickness outer diameter tapered outwardly away from the hose barb inner end, (c) locating a cylindrical retaining sleeve over the hose grips to retain the hose grips on the end of the hose, the retaining sleeve having its inner diameter tapered from one end to the other end to match the outer diameter taper of the hose grips, (d) axially pushing an outer sleeve against the retaining sleeve to force the retaining sleeve off the hose grips toward the hose barb outer end, and (e) securing the outer sleeve against moving axially back over the hose grips. The hose grips together substantially surround the end of the hose with spacing between one another in an axial direction prior to step (c), and the hose grips each extend beyond the inner end of the hose barb. Further, the outer sleeve has a tapered inner diameter with a maximum diameter substantially matching the smallest diameter of the retaining sleeve whereby the outer sleeve presses the hose grips further during step (d).

In one form of this aspect of the present invention, the securing step includes mounting a removable retaining ring to the outer sleeve.

In another form of this aspect of the present invention, a method of detaching a hose barb from a hose secured together by the above method is provided, including the steps of (f) removing the retaining ring from the outer sleeve, (g) axially pushing the outer sleeve with the retaining sleeve in the opposite direction to force the outer sleeve off the hose grips, (h) removing the hose grips from the hose; and (I) pulling the hose from the hose barb.

### BRIEF DESCRIPTION OF THE DRAWINGS

FIG. 1A is a cross-sectional view of a hose coupling according to the present invention during an initial stage of assembly;

FIG. 1B is a view similar to FIG. 1A in a further stage of assembly;

FIG. 1C is a cross-sectional view of the assembled hose coupling;

FIG. 2 is an exploded perspective view of the hose coupling of FIG. 1C;

FIG. 3A is a cross-sectional view of the hose coupling during an initial stage of disassembly;

FIG. 3B is a view similar to FIG. 3A in a second stage of disassembly;

FIG. 3C is a view similar to FIG. 3B, but showing a further stage of disassembly; and

FIG. 3D is a view similar to 3C, but showing the hose coupling at the final stages of disassembly.

### DETAILED DESCRIPTION OF THE INVENTION

In accordance with the present invention, a field changeable sanitary hose end connector is provided which requires only new hose gripping malleable inserts and a clean hose end to fully restore the connection to an “as-new” condition. The structure creates a high pressure conforming grip on the hose, forming a high pressure sanitary grip on the inside and the outside of the hose that is crevice free, thereby assuring the ability to clean the hose in place.

An exemplary embodiment of a hose coupling 10 according to the present invention is illustrated in the Figures.

The coupling 10 includes a hose barb 12 defining a sanitary passage 14 between an inner end 16 securable to a hose 20 and an outer end 22 suitably securable to a sanitary line (not shown).

The hose barb 12 includes a grooved annular outer surface 24 about the sanitary passage 14 adjacent the inner end 16 (though advantageously the grooves do not extend completely to the inner end 16. It should be appreciated, once a full understanding of the present invention is had, that these grooves my be of various orientations, including separate concentric grooves as well as threaded grooves. Threaded grooves may be advantageously used as they facilitate removal of the hose 20 from the hose barb 12 as described further below, whereby the hose 20 may be more readily unscrewed off the barb inner end 16 after long periods of deformation of the hose 20 over the grooves.

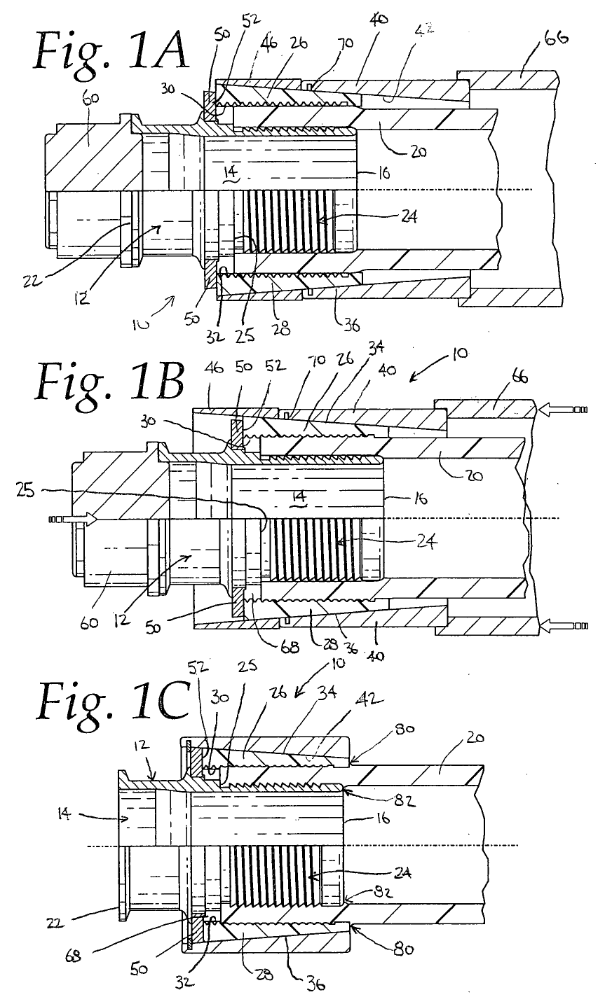

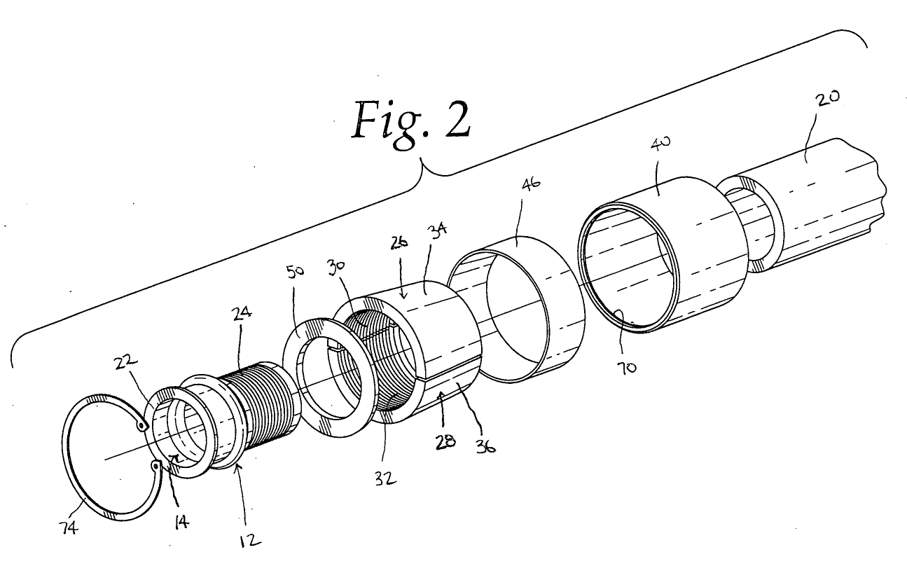

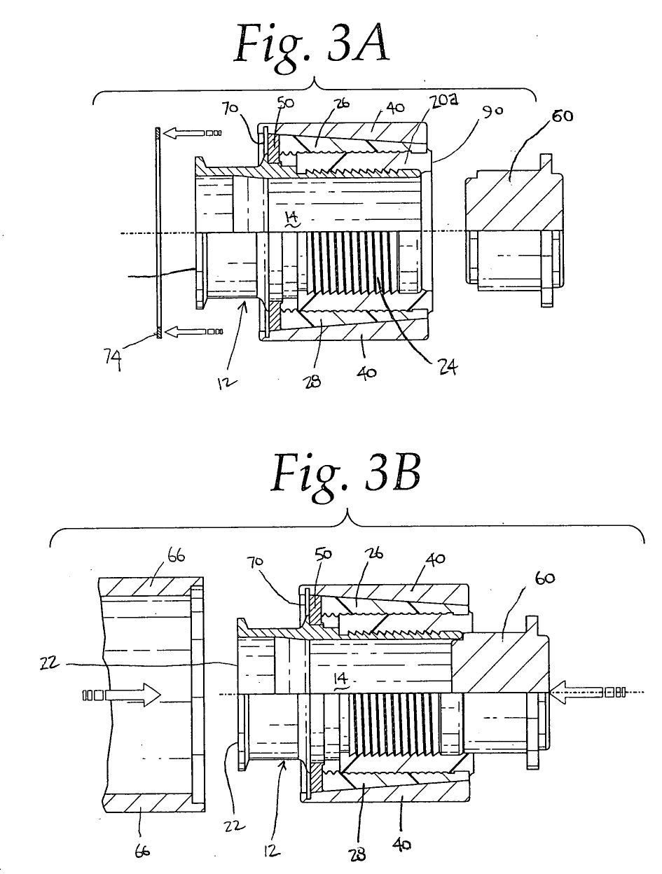

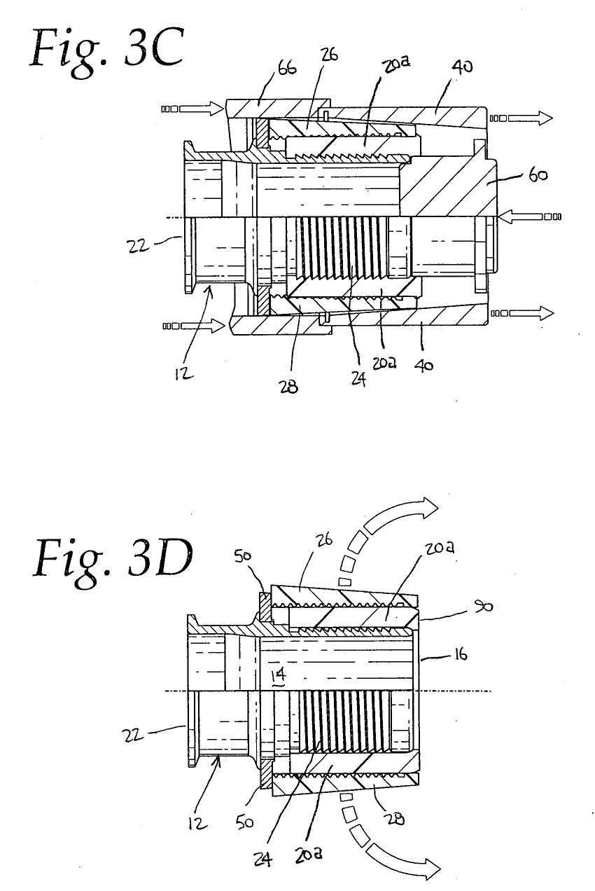

The hose barb 12 also includes a radial step 25 which is spaced from and faces said hose barb inner end 16. The face of the radial step 25 defines a stop for the end of a hose 20 disposed over the hose barb inner end 16 as can be seen in FIGS. 1A-1C and 3A-3D.

The coupling 10 further includes at least two malleable hose grips 26, 28, each defining a partially cylindrical segment having a grooved inner diameter 30, 32 and an outer diameter 34, 36 tapered from one end to the other end, with the inner end having a smaller diameter than the outer end. The taper of the hose grips may advantageously be between about 3 and 6 degrees from the axial direction.

The hose grips 26, 28 together are adapted to substantially surround a hose 20 disposed over the hose barb grooved annular outer surface 24, with some space allowing for compression of the hose 20. Thus, where two hose grips 26, 28 are provided such as illustrated in the Figures, each hose grip 26, 28 is generally semi-cylindrical but sized so that if their edges were brought together without distorting the grips 26, 28, they would define an inner diameter which is less than the outer diameter of the hose 20 to which the coupling 10 is to be attached.

An outer sleeve 40 defines a central truncated conical passage 42 which is tapered from one end to the other end to generally match the outer diameter taper of the hose grips 26, 28. Thus, the taper of the outer sleeve opening may also advantageously be between about 3 and 6 degrees from the axial direction. The outer sleeve 40 is used with a retaining sleeve 46 to facilitate easy assembly of the coupling 10 and hose 20 to provide an excellent connection as described further below.

An annular ring 50 is suitably secured around the hose barb 12 (e.g., by welding) and defines an annular face 52 facing the hose barb inner end 16. The ring annular face 52 defines an axial stop for the hose grips 26, 28 during assembly, and the opposite face of the annular ring 50 also serves to assist in retaining the coupling 10 in an assembled condition as described below.

As previously noted, the hose grips 26, 28 are preferably made of a malleable material such as urethane or ultra high moledular weight (UHMW) materials, preferably having at least an 80 durometer hardness and advantageously around a 90 durometer hardness. By contrast, the hose barb 12 and outer sleeve 40 may advantageously be made of stainless steel. It should further be appreciated that the hose grips 26, 28 may be selected according to the hardness and size of the hose 20.

Assembly of the hose coupling 10 to a hose 20 may be advantageously accomplished as best illustrated in FIGS. 1A-1C.

First, the outer sleeve 40 and then the retaining sleeve 46 are moved over the end of the hose 20 and onto the hose 20. Though the sleeves 40, 46 are not used until later in assembling the coupling 10, it is desirable to have them in position on the hose 20 initially so that they can be moved into position from the hose 20 as will become apparent.

A sanitary end of the hose 20 is then located over the inner end 16 of a sanitized hose barb 12. The hose 20 is pushed over the hose barb 12 until its end abuts the stop defined by the face of the radial step 25. Sanitary lubricant may be used to facilitate this step.

The set of malleable hose grips 26, 28 is then located over the end of the hose 20 and the hose barb inner end 16 so as to substantially surround the end of the hose 20. Advantageously, the selected size of the hose grips 26, 28 is such that, when manually located over the hose 20, there is a spacing or gap between them in an axial direction. Further, the axial length of the hose grips 26, 28 can also advantageously be such as to extend beyond the inner end 16 of the hose barb 12 when abutting on the outer end against the annular face 52 of the annular ring 50. Still further, when locating the hose grips 26, 28 over the hose 20, they may be advantageously placed directly against the radial step 25, which prevents the grips 26, 28 from undesirably sliding into place during assembly.

With the hose grips 26, 28 in place over the hose 20, the generally cylindrical retaining sleeve 46 may be manually slid off the hose and over the grips 26, 28 to hold them generally in place on the hose 20. The inner diameter of the retaining sleeve 46 is slightly tapered about 3 to 6 degrees to generally match the taper of the outer diameter of the hose grips 26, 28 and thereby define defining a truncated conical shape on the inner diameter. The retaining sleeve 46 is sized so that it may be manually slid onto the inner end and over the hose grips 26, 28 to apply some radial forces which will frictionally retain the components together.

It should be appreciated that the retaining sleeve 46 has a minimum inner diameter which is at least as great as the outer diameter of the annular ring 50 so that the retaining sleeve 46 may slide all the way over the annular ring 50.

At this point, the coupling 10 is in position whereby it may be finally assembled. During final assembly, the hose barb inner end 22 may be secured against a fixed base member or plug 60 (see FIGS. 1A and 1B) and the outer sleeve 40 is pushed by a suitable tool 66 over the inner end of the hose grips 26, 28.

As the outer sleeve 40 is pushed axially, it moves to eventually engage the outer end of the retaining sleeve 46 and then begin sliding the retaining sleeve 46 off the outer end of the hose grips 26, 28 (see FIG. 1B). Advantageously, the maximum inner diameter of the outer sleeve 40 (at its outer end) is substantially equal to the minimum inner diameter of the retaining sleeve 46 (at its inner end).

As the outer sleeve 40 is moved axially over the hose grips 26, 28 toward the outer end of the hose barb 12, it also presses the hose grips 26, 28 radially together and further will cause the hose grips 26, 28 to change shape slightly due to their malleable nature, with the result being that at that point the outer sleeve 40 must be pushed at high pressure with a resulting high pressure bond thereby formed between the hose barb 12 and the inner surface of the hose 20, and the hose grips 26, 28 and the outer surface of the hose 20. Distortion will occur not only with the malleable hose grips 26, 28 but also the hose 20, particularly given the grooves on the hose barb outer surface 24 and the inner diameter 30, 32 of the hose grips 26, 28, to thereby create an outstanding pressure bond between the components. The void 68 adjacent the barb radial step 25 provides a space for the hose grips 26, 28 (and hose end) to flow into if excessive pressure is built up during assembly.

To complete assembly of the hose coupling 10, the outer sleeve 40 is pushed sufficiently toward the outer end that an inner groove 70 in the outer sleeve 40 is pushed past the annular ring 50. A suitable retaining ring 74 is then placed in the inner groove 70, at which point the base member 60 and tool 66 may be removed, as assembly is complete. Internal pressures on the components will tend to cause the outer sleeve 40 to slide back off (toward the inner end), but the retaining ring 74 will engage the outer end of the annular ring 50 to stop such movement and retain the coupling 10 in a good assembled position. While the illustrated retaining ring 74 is suitable, it has also been found, for example, that a coiled ring (e.g., coiled around 720 degrees) may also be advantageously used, which ring may be easily located in the groove 70 as well as easily removed during disassembly (as discussed further below).

It should be appreciated that the tool 66 may advantageously include split parts which may be removed from the hose 20 after use by pulling them away radially.

It should also be appreciated that the provision of hose grips 26, 28 and annular sleeve 40 with an axial length which extends slightly beyond the inner end 16 of the hose barb 12, a good seal around the outside of the hose 20 is provided without any crevices (at 80 in FIG. 1C), and more critically a good seal is provided around the inside of the hose 20 without any crevices (at 82 in FIG. 1C), thereby avoiding unsanitary conditions which can arise from such crevices in prior hose couplings. For example, washing the coupling 10 and hose 20 may be done periodically by running cleaning fluids (e.g., water and cleaning agents) through them, and crevices such as at 82 may not be properly cleaned by such washing procedures.

The hose coupling 10 may similarly be readily disassembled as illustrated in FIGS. 3A-3D.

In such disassembly, the hose 20 may be cut in any suitable manner just beyond the inner end of the coupling 10 (at 90 in FIG. 3A), and the retaining ring 74 removed from the inner groove 70 of the outer sleeve 40 (see FIG. 3A). (This may be facilitated by first pressing the outer sleeve 40 toward the outer end, such as during assembly, to remove the pressure on the retaining ring 74 from the annular ring 50.) The base member 60 may then be used to secure the inner end of the assembly by locating it against the inner end of the hose barb 12 (see FIG. 3B). It should be appreciated that a unitary base member 60 may be advantageously used which has a diameter on one end which can engage around the outer end 22 of the hose barb 12 during assembly and a diameter on the other end which can engage around the inner end 16 of the hose barb 12 during disassembly.

In this condition, the tool 66 may be brought into engagement with the outer end of the outer sleeve 40 to apply a force sufficient to force the outer sleeve axially off of the hose grips 26, 28 (see FIGS. 3B-3C). It should be appreciated that the retaining sleeve 46 may also be used in disassembly, with the tool 66 used to push the retaining sleeve 46 against the outer sleeve 40 rather than engaging the outer sleeve 40 directly as shown in FIG. 3C.

With the outer sleeve 40 clear of the coupling 10, the grips 26, 28 may be pulled radially from the hose 20 (see FIG. 3D) and the scrap of hose 20a may be removed from the hose barb 12 (e.g., by unscrewing if threaded grooves are used around the inner end of the hose barb 12).

It should be appreciated that the hose coupling 10 may thus be readily removed and reassembled. Thus, while removal for cleaning purposes should not usually be required (as the inside of the parts stays clean and it is therefore usually sufficient to clean the entire coupling 10 as a unit without disassembly), when replacement is appropriate (e.g., when the hose is damaged such as by being driven over by a truck, or the end of the hose is damaged by repeated stress on the hose 20 at the coupling 10), it can be readily accomplished. For example, since almost all hoses are made longer than the actual process requirements, it is possible to cut the hose back as with the above described disassembly and reuse the hose 20 and the coupling 10. Further, sometimes hoses fail from physical damage beyond repair and the hose needs to be replaced. The hose coupling of the present invention may be reused in such situations, and thereby provide savings to the hose user. When the coupling is reused, simple cleaning of the components may be accomplished before assembly.

It should be appreciated that different hoses can be readily accommodated by different sizes of coupling components to provide optimum grip pressure. Testing has shown that less gripping pressure should be used with polymer hoses than with built-up hoses.

Moreover, it should be appreciated that the present invention may be advantageously used with a variety of hose configurations. For example, sanitary hoses vary in strength and hardness (durometer), and polymer hoses may have a relatively uniform density whereas “built-up” hoses often have a very dense covering or jacket with a softer sanitary lining. Because of this the force with which the hose is gripped needs to vary so as to provide optimum strength of the connection without weakening the integrity of the hose, or the sanitary lining in the inner diameter of “built-up” hoses. This may be achieved with the present invention by the use of appropriate sized hose grips 26, 28 (the inner diameter of the hose grips 26, 28 directly controls the compression pressure on the retained hose 20) as well as by providing a uniform diameter without sharp edges at the inner end 16 of the hose barb 12.

It should also be appreciated that the large outer diameter of the outer sleeve 40 will assist in ensuring that the connecting ferrule at the outer end of the house coupling 10 will be held off the potentially unsanitary surface should the hose 20 and coupling 10 be laid down by the worker for some reason when connecting or disconnecting it.

Further, it should be appreciated that the hose coupling 10 of the present invention lowers the stress on the hose end by compressing the hose 20 inward instead of expanding the hose and stressing the basic fabric structure of the hose. Also there is no rotation during assembly that could jeopardize the integrity of the sanitary lining of the hose 20.

Still further, it should be appreciated that an outer sleeve 40 of a given diameter may be used with a variety of hose diameters by using different size hose grips 26, 28.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A coupling for securing a hose to a sanitary line, comprising:
a hose barb defining a sanitary passage between an inner end securable to a hose and an outer end securable to a sanitary line, said hose barb including a grooved annular outer surface about the sanitary passage adjacent the inner end;
at least two malleable hose grips each defining a partially cylindrical segment having a grooved inner diameter and an outer diameter tapered from one end to the other end, said hose grips together being adapted to substantially surround a hose disposed over said hose barb grooved annular outer surface;
an outer sleeve defining a central truncated conical passage, said passage being tapered from one end to the other end to match the outer diameter taper of said hose grips;
wherein when said hose grips are positioned to surround a hose disposed over said hose barb grooved annular outer surface,
said hose grips are sized to be spaced apart from one another along their edges, and
said outer sleeve is sized so that when forced axially over said hose grips, said hose grips are pressed together and against the hose to create a pressure bond between the hose barb and the hose.

2. The coupling of claim 1, wherein when said hose grips are positioned to surround a hose disposed over said hose barb grooved annular outer surface, said one end of each of said hose grips extends beyond said inner end of said hose barb to also surround a portion of the hose which is not over the hose barb inner end.

3. The coupling of claim 1, wherein said hose barb grooved annular outer surface and said grooved inner diameter of said hose grips bind against the inner and outer surfaces of the hose, respectively.

4. The coupling of claim 1, wherein said hose barbed grooved annular outer surface is adjacent to but spaced from the hose barb inner end.

5. The coupling of claim 1, wherein said hose grips when pressed together have a pressure bond with the outer surface of the hose.

6. The coupling of claim 1, wherein the taper of the hose grips and the outer sleeve cylindrical opening is between about 3 and 6 degrees from the axial direction.

7. The coupling of claim 1, wherein said hose barb and outer sleeve are stainless steel.

8. The coupling of claim 1, wherein said hose barb includes a radial step which is spaced from and faces said hose barb inner end, said radial step face defining a stop for the end of a hose disposed over the hose barb inner end.

9. The coupling of claim 8, further comprising an annular stop ring having one annular face facing said hose barb inner end, said annular face defining an axial stop for said hose grips and being spaced further from said hose barb inner end than said radial step.

10. The coupling of claim 1, further comprising an annular stop ring having one annular face facing said hose barb inner end, said annular face defining an axial stop for said hose grips.

11. The coupling of claim 10, wherein said outer sleeve has an end extending beyond said annular stop ring when secured over said hose grips, and further comprising a retaining ring mountable in said outer sleeve truncated conical passage whereby said retaining ring engages the opposite annular face of said stop ring to retain said outer sleeve over said hose grips.

12. The coupling of claim 1, wherein said hose grips are selected according to the size of the hose.

13. The coupling of claim 1, wherein said hose grips are selected according to the hardness and size of the hose.

14. A method of securing a hose barb to a hose to create a sanitary connection, wherein the hose barb defines an axial sanitary passage between an inner end securable to a hose and an outer end securable to a sanitary fine and includes a grooved annular outer surface about the sanitary passage adjacent the inner end, comprising the steps of:
locating the end of a hose over the inner end of the hose barb;
locating at least two malleable hose grips over the end of the hose and the hose barb inner end, wherein each hose grip defines a partially cylindrical segment having a grooved inner diameter and a tapered thickness outer diameter tapered outwardly away from the hose barb inner end, wherein
said hose grips together substantially surround the end of the hose with spacing between one another in an axial direction, and
said hose grips each extend beyond the inner end of the hose barb;
locating a cylindrical retaining sleeve over said hose grips to retain said hose grips on the end of the hose, said retaining sleeve having its inner diameter tapered from one end to the other end to match the outer diameter taper of the hose grips;
axially pushing an outer sleeve against the retaining sleeve to force said retaining sleeve off said hose grips toward said hose barb outer end, wherein said outer sleeve has a tapered inner diameter with a maximum diameter substantially matching the smallest diameter of the retaining sleeve whereby said outer sleeve presses said hose grips further together as the outer sleeve is pushed axially over said hose grips; and
securing said outer sleeve against moving axially back over the hose grips.

15. The method of claim 14, wherein said securing step comprises mounting a removable retaining ring to said outer sleeve.

16. A method of detaching a hose barb from a hose secured together by the method of 15, comprising the steps of:
removing said retaining ring from said outer sleeve;
axially pushing the outer sleeve with the retaining sleeve in the opposite direction to force said outer sleeve off said hose grips;
removing said hose grips from said hose; and
pulling said hose from said hose barb.
